(19) United States
(12) Patent Application Publication
(10) Pub. No.: US 2022/0026569 A1
(43) Pub. Date: Jan. 27, 2022

(54) Smartphone-, tablet- or laptop-based motion detection system using Doppler Effect and audio processing

(71) Applicant: Jens Nicolai Plesner, Woluwe Saint Pierre (BE)

(72) Inventor: Jens Nicolai Plesner, Woluwe Saint Pierre (BE)

(21) Appl. No.: 17/248,891

(22) Filed: Feb. 12, 2021

Related U.S. Application Data
(60) Provisional application No. 62/980,628, filed on Feb. 24, 2020.

(51) Int. Cl. G01S 15/62; G01S 15/58

(52) U.S. Cl. CPC G01S 15/62; G01S 7/521; G01S 15/586

(57) ABSTRACT

A system and methods are described that implement a consumer device (smartphone-, tablet- and/or lap top) configured to detection motion via an application program installed on the devices non-transitory medium. The application program contains computer readable instructions instructing the device to perform a number of tasks and configures the device processor to detect motion using Doppler Effect and audio processing. The system uses existing hardware and software in devices (smartphones, tablets or laptops) including the devices non transitory computer readable medium comprising the application program with computer readable instructions, which upon activation, commands the device to transmit ultrasound (18.0-22.0 kHz) and receive the return sound, while the application program configures the device processor to use audio processing to identify shifts in transmitted sound frequency caused by Doppler Effect created by movement of an object or a person. The audio processing effectively turns the device into a short-range motion detector—effective up to 10 meters—detecting movement (not speed or direction) of human sized objects. When Doppler Effect data processing confirms movement, the application program can command the device to initiate a sequence of actions.

### BACKGROUND OF THE INVENTION

Motion detection is commonly associated with alarm systems based on costly stationary hardware and surveillance subscriptions. Technological advances of consumer devices (smartphones, tablets and lap-tops) incorporating loudspeakers, microphones, cameras, storage media and data processing capacity as standard, makes a consumer device a possible and portable alternative to a traditional alarm system.

Existing device-based motion detection methods use picture analysis and/or Artificial Intelligence to detect motion using the device camera as sensor, and thus are sensitive to light intensity, direction of camera, dust, entropy and “training errors” etc.

The system of the Claims, enables a device to create Doppler Effect by emitting ultrasound and identifying a frequency shift of the returning ultrasound created by motion of an object reflecting the ultrasound. By configuring the device processor to perform audio processing, motion is detected while avoiding sensitivity to environmental conditions such as light intensity, direction of camera, dust, entropy and “training errors”, and thus improving the signal to noise ratio of device-based motion detection.

### BRIEF SUMMARY OF THE INVENTION

A system and processes are described that implement devices including smartphones, tablets or laptops with a non-transitory computer readable storage medium comprising the application program with computer readable instructions commanding the device(-s) to emit a constant ultrasound frequency (18.0-22.0 kHz), analyze the reflected ultrasound for Doppler Effects (frequency shifts) using audio processing and detect motion of a moving person or object.

The device(-s) use existing device hardware and software including loudspeaker(-s), microphone(-s), non-transitory storage media, processors etc. and the application program of the Claims, to emit, receive and process sound to identify Doppler Effects using audio processing, to isolate ultrasound signals caused by movement.

When a shift of the emitted ultrasound frequency is detected confirming motion, the method activates the device camera, documents the incident, uploads documentation to the user's cloud account while simultaneously sending a notification to one or more devices activated with the same user-ID.

The object of the invention is to provide consumers with a reliable, affordable and subscription free motion detection alternative—including picture documentation for insurance purposes. According to “statista.com” smartphones alone have ca. 3.8 bn users globally and global sales are averaging ca. 1.5 bn devices/year since 2015. The rapid replacement of smartphones indicates a large number of available dis-used smartphones available, which could be used as motion detectors.

### BRIEF DESCRIPTION OF DRAWINGS

FIG. 1. Chart illustrating system components,

FIG. 2. Example of devices,

FIG. 3. Example environment with device-based motion detection program active, emitting ultrasound at a frequency between 18-22 kHz

FIG. 4. Example of environment with devicebased motion detection program active, and frequency changes (Doppler Effect) caused by motion of a non-distributed object (human body) or a distributed object (door or window) in the example environment,

FIG. 5. Illustration of method used to process audio and define range of interest,

FIG. 6a. Range of interest without movement, in which case the emitted ultrasound returns as a constant scattered signal

FIG. 6b. Range of interest with Movement, in which case the signal scattering becomes reduced and/or amplified depending on the speed, direction and distribution of the moving object.

FIG. 7. Flow chart illustrating processes and triggered actions.

FIG. 8. Example illustration of system connected to external loudspeaker.

### A DETAILED DESCRIPTION OF THE INVENTION

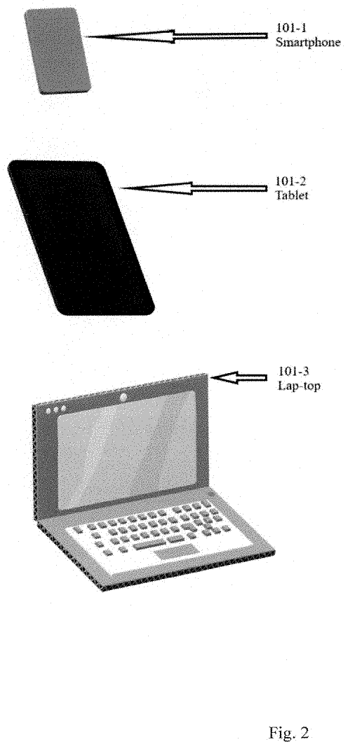

Integrating a system adding motion detection capabilities to consumer devices 101-1, 101-2, 101-3, FIG. 2 is challenged by the devices limitations such as available power, position of transmitters (loudspeakers) and sensors (microphones and cameras), data processing power, loudspeaker frequency limitations, microphone sampling rates etc. as well as environmental conditions, and the nature and distance of the object being detected.

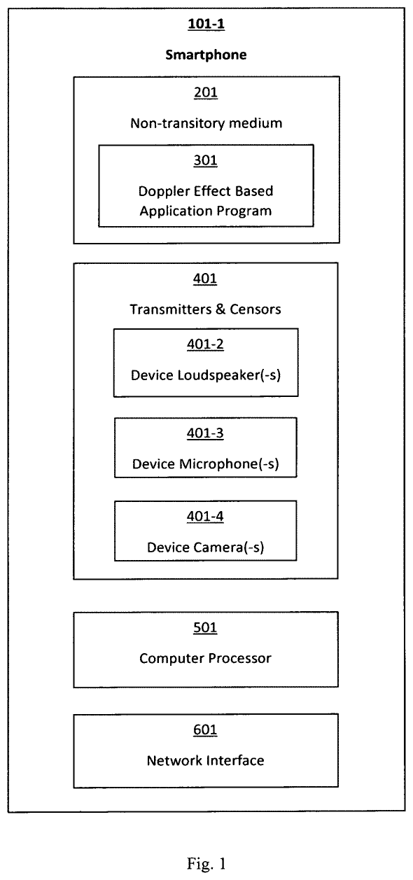

This describes a system and methods FIG. 1 comprising a consumer device 101-1 comprising loudspeaker(-s) 401-2, microphone(-s) 401-3, camera(-s) 401-4, a non-transitory storage medium 201, processor(-s) 501, an application program 301 downloaded to the devices non-transitory medium, enabling a device-based motion detection process capable of detecting motion of human size objects including windows and doors within a range of ca. 10m. and a net-work interface 601.

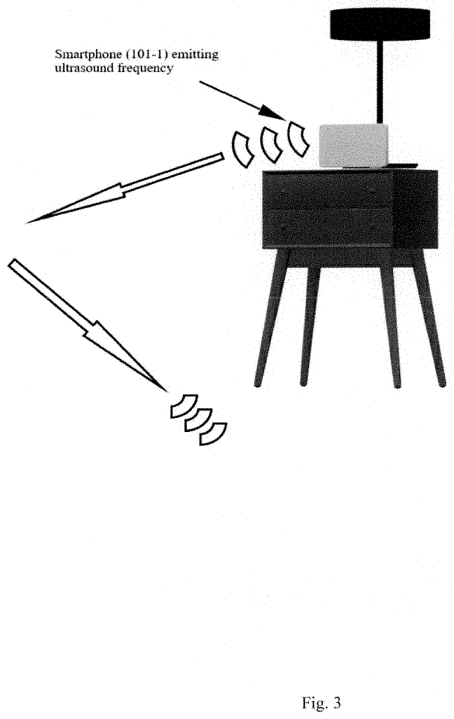

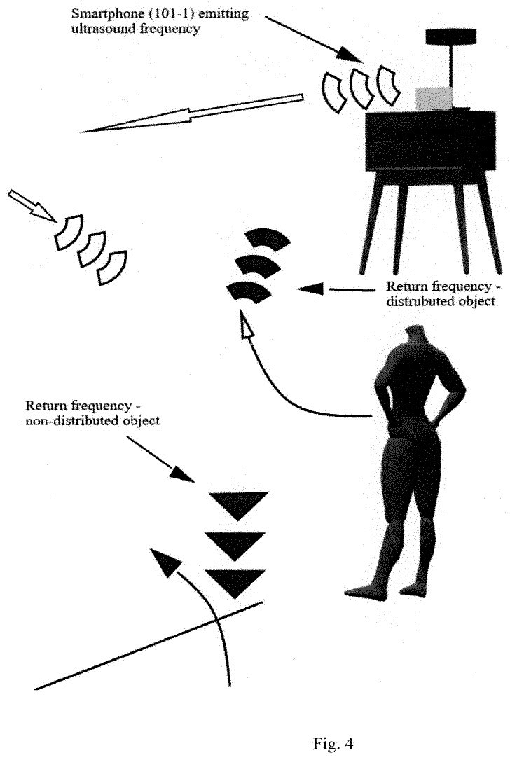

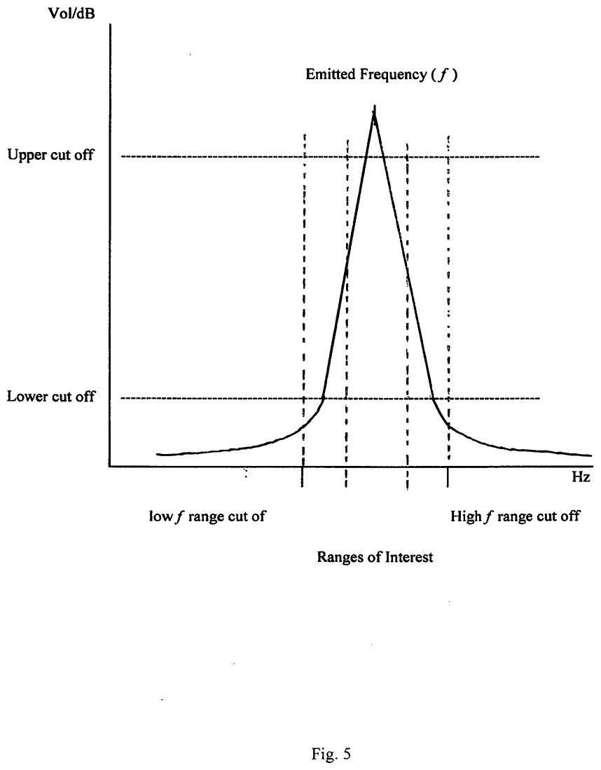

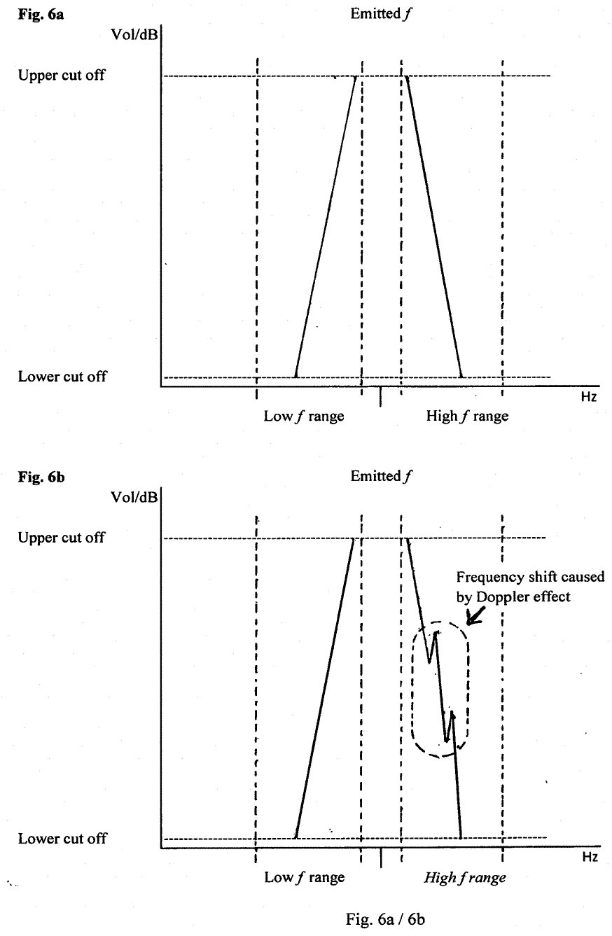

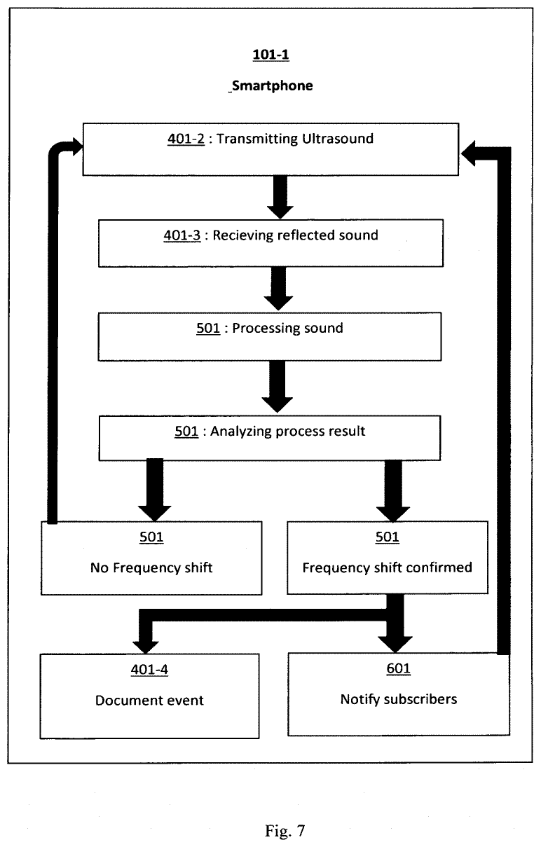

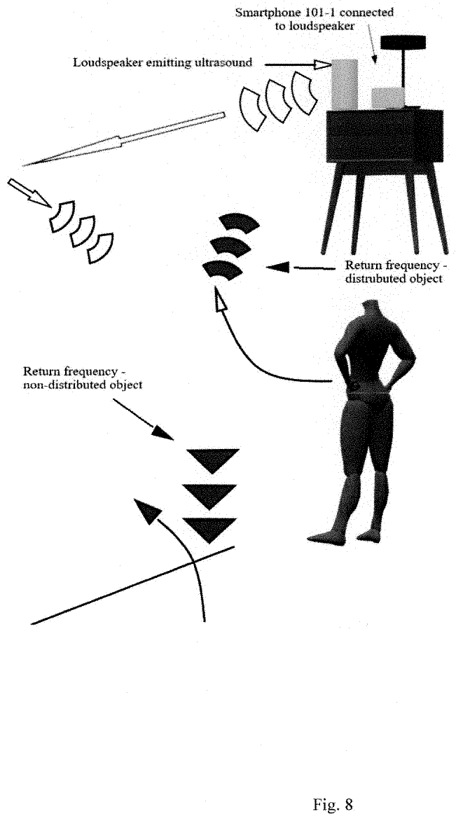

When a device 101-1 FIG. 2. emits a constant ultrasound FIG. 3, the device microphone 401-3 can receive the identical signal together with all other sound signals present. If an object or person is moving within the range of the device 101-1 FIG. 4, said object or person will cause small but identifiable shifts in the ultrasound frequency (Doppler Effect), and by configuring the device processor 501 to use audio processing FIG. 5 the Doppler Effect can be identified and isolated from other sounds FIG. 6a and FIG. 6b thereby detecting motion. The application program 301 can then command the device to initiate a sequence of actions FIG. 7, similar to the actions of an alarm system. Connecting the device FIG. 2 to an external loudspeaker can increase the motion detection range covered by the device FIG. 8.

The described system enables the device to detect such motion using the device loudspeaker(s-) 401-2 to emit an ultrasound signal (18.0-22.0 kHz) and the device microphone 401-3 to receive audio (0.02-22.0 kHz) and to configure the device processor 501 to perform audio processing in order to identify and detect shifts in the emitted ultrasound frequency caused by objects moving within the range of the device.

The shift in emitted ultrasound frequency is caused by movement of objects reflecting the sound (Doppler Effect).

Doppler Effect can be created by an object moving through sound waves with frequency (f₀), reflecting the sound waves and causing the sound wave frequency to shift to (f), which depending on the distribution, velocity and direction of the moving object is then given by

$$f = ( \frac{c}{c \pm {v}_{0}} ) {f}_{0} ,$$

where:

c=is the constant speed of the sound waves,

v₀=the variable speed of the moving object

Knowing f₀ and c, and estimating v₀, the application program configures the processor 501 to isolate the approximate frequencies (±f) and detect/report significant changes in narrow frequency ranges around ±f caused by motion—FIG. 6a and FIG. 6b.

A moving distributed object (e.g., a human body) creates a more scattered frequency shift than a non-distributed object (e.g., a door or window) and hence, the frequency shift is not to a specific wavelength but to a range of wavelengths near to (±f).

The audio processing is performed by a program classifying sound in the 20-22,000 Hz range by Hz and volume, hence configuring the audio processing processor to:
ignore sounds below/above certain levels (volume), and
identify sound in ranges specific to the calculated frequency shift above and below the transmitted frequency (18.0-22.0 kHz).

The audio processing is performed in real time and identification of sound in the ranges specific to the calculated frequency shift will command the application program to configure the device processor 501 to document the cause of the frequency shift using the device camera 401-4 and non-transitory medium 201, and alert one or more connected devices using the devices network interface 601.

The described system can be used in a variety of devices with different specifications and using different program languages.

1. A system comprising a consumer device (smartphone, tablet, lap-top) with a non-transitory computer readable storage medium storing computer readable instructions and wherein a processor coupled to the non-transitory medium can be configured by an application program to execute instructions enabling the device to emit a constant sound frequency, receive the return sound frequency, process and analyze the return sound frequency for frequency shifts caused by Doppler Effects by configuring the processor(-s) to perform audio processing and analyses.

2. A method, comprising: downloading, by a consumer device (smartphone, tablet, lap-top), of at least one application program containing computer readable instructions, to the devices non-transitory storage medium, which upon user activation of the application program configures the device to emit a constant sound frequency, receive the return sound frequency, and configures the device processor(-s) to analyze the return sound frequency for frequency shifts caused by Doppler Effects that are created by a person or object moving in the motion detection range of the device.

3. The method of claim 2, wherein the consumer device (smartphone, tablet, lap-top), is connected to an external loudspeaker emitting the constant sound frequency thereby increasing the motion detection range of the device.
